(19) United States
(12) Patent Application Publication
(10) Pub. No.: US 2026/0313699 A1
(43) Pub. Date: Oct. 8, 2026

(54) RANDOM ACCESS REPORTING METHOD AND USER EQUIPMENT

(71) Applicant: Sharp Kabushiki Kaisha, Sakai City, Osaka (JP)

(72) Inventors: Ningjuan CHANG, Shanghai (CN); Renmao LIU, Shanghai (CN)

(21) Appl. No.: 19/481,649

(22) PCT Filed: May 7, 2024
(86) PCT No.: PCT/CN2024/091437

§ 371 Date: Nov. 5, 2025

(30) Foreign Application Priority Data
May 8, 2023 (CN) 202310512652.2

(51) Int. Cl. H04W 74/0833; H04W 36/00

(52) U.S. Cl. CPC H04W 74/0833; H04W 36/0072

(57) ABSTRACT

Provided in the present application are a random access reporting method and a user equipment. The random access (RA) reporting method includes: executing, by a user equipment (UE), a random access (RA) procedure for layer 1/layer 2-triggered mobility (LTM); determining, by the UE, that the RA procedure is completed; and storing, by the UE, LTM-related RA information in an RA report, where the LTM-related RA information includes at least one instance of the following information: RA information used to indicate that the random access procedure is used for early RA acquisition for LTM, and RA information used to indicate whether random access response reception of the RA procedure is configured.

### TECHNICAL FIELD

The present disclosure relates to the technical field of wireless communications. More specifically, the present disclosure relates to a random access reporting method and a corresponding user equipment.

### BACKGROUND ART

Network optimization can be performed in a wireless network to achieve the goal of optimizing network performance. Generally, techniques such as data acquisition and data analysis are used to ascertain the causes of poor network quality in existing deployed and operating networks, and techniques such as modifying configured network parameters and adjusting the network structure and deployed devices are adopted to improve network performance. In a self-configuration and self-optimization network (SON), optimization refers to a process of automatically adjusting the network on the basis of measurement/performance measurement of a user equipment and/or a base station. The network side can configure the UE to execute measurement for a SON. There are many SON functions, for example, an automatic neighbor relation (ANR) function for reducing the neighbor cell management burden of an operator, a mobility load balancing (MLB) function for balancing loads among different cells, a mobility robustness optimization (MRO) function for optimizing mobility performance, a random access channel optimization function for optimizing random access channel parameters, and a radio link failure report function for optimizing coverage and MRO.

In addition, minimization of drive tests (MDT) technology is also an important means for operators to optimize networks. Network optimization related parameters are acquired from drive test data obtained by the UE, and a network deployment status and an operation status are acquired based on analysis on the data, so as to decide how to improve the network operation status. Main application scenarios of MDT are coverage optimization, capacity optimization, mobility management optimization, QoS parameter optimization, common channel parameter configuration optimization, etc.

In NR systems of release 17 or earlier versions, a random access (RA) report is used to record information about a random access procedure executed on a UE side, so as to be used by a network side to optimize issues such as random access parameters and network coverage.

In NR systems of release 18, a discussion is underway to introduce a layer 1/layer 2 (L1/L2)-triggered mobility (LTM) mechanism. The purpose of this mechanism is to reduce mobility delay. In NR systems of versions earlier than release 18, mobility is mainly implemented by using handover (also referred to as reconfiguration with sync) triggered by radio resource control (RRC) layer signaling based on a measurement result of layer 3. During a handover procedure, a UE releases a source serving cell and adds a target serving cell, and needs to execute a complete layer 1 and layer 2 reset operation. This causes a long mobility procedure delay, high overhead, and a long data interruption time. In the LTM mechanism, an RRC configuration of a target candidate cell is issued to the UE in advance, and subsequently, a cell change is triggered by using layer 1/layer 2 signaling based on a measurement result of layer 1,thereby achieving the objective of reducing the delay, the overhead, and the interruption time.

The present disclosure is intended to achieve random access information reporting in an NR network, and further achieve RA reporting in an LTM-supported network.

### SUMMARY OF THE INVENTION

A main objective of the present disclosure is to provide an RA reporting method and a user equipment, so that reporting of LTM-related performance information can be implemented in an LTM-supported system, and random access information configuration for RA reporting can be implemented in an LTM scenario.

According to a first aspect of the present disclosure, an RA reporting method is provided, comprising: executing, by a user equipment (UE), a related random access (RA) procedure for layer 1/layer 2-triggered mobility (LTM); determining, by the UE, that the RA procedure is completed; and storing, by the UE, LTM-related RA information in an RA report, where the storage of LTM-related RA information comprises one or more of the following operations: operation 1: setting a value of first RA information to indicate that the RA procedure is for LTM; operation 2: setting a value of an raPurpose information element to indicate that a scenario in which the RA procedure is triggered is early TA acquisition for LTM; operation 3: if the RA procedure is triggered by a physical downlink control channel (PDCCH) order, setting the value of the raPurpose information element to ulUnSynchronized; operation 4: if the random access procedure is executed on an LTM candidate cell for a master cell group (MCG), setting, by the UE, a value of third RA information to primary cell (PCell) information; or if the random access procedure is executed on an LTM candidate cell for a secondary cell group (SCG), setting, by the UE, the value of the third RA information to primary secondary cell (PSCell) information; operation 5: if the random access procedure is executed on an LTM candidate cell, setting the value of the third RA information to the PCell information; operation 6: if the random access procedure is executed on the LTM candidate cell, setting the value of the third RA information to a serving cell identity configured by a network side; operation 7: setting a value of fourth RA information to indicate whether the RA is configured with random access response (RAR) reception; and operation 8: setting a value of fifth RA information to indicate initial transmit power information of a random access preamble in the RA procedure.

In the RA reporting method according to the first aspect, the RA procedure is used to acquire a timing advance (TA) amount of the LTM candidate cell in advance before a cell switch, and the RA procedure is triggered by a PDCCH order sent on a serving cell.

In the RA reporting method according to the first aspect, when an LTM candidate cell corresponding to an executed RA procedure is configured with the RAR reception, the UE executes one or a plurality of operation 1 to operation 8.

In the RA reporting method according to the first aspect, in the third RA information, the PCell information is a PCell global cell identity or a physical cell identity and a carrier frequency, and the PSCell information is a PSCell global cell identity or a physical cell identity and a carrier frequency.

In the RA reporting method according to the first aspect, the serving cell identity configured by the network side refers to a cell identity or an index value configured by the network side for the associated LTM candidate cell to execute the RAR reception.

In the RA reporting method according to the first aspect, when the RA is configured with the RAR reception, the value of the fourth RA information is set to indicate that the RA is configured with the RAR reception, or when the RA is not configured with the RAR reception, the value of the fourth RA information is set to indicate that the RA is not configured with the RAR reception.

In the RA reporting method of the first aspect, the UE receives a UE information request (UEInformationRequest) message from a base station, wherein the message comprises an indication for requesting the UE to report the stored RA report; and the UE includes, in a UE information response (UEInformationResponse) message on the basis of the indication, the stored RA report comprising one or a plurality of the first RA information to the fifth RA information, and sends the same to the base station.

According to a second aspect of the present disclosure, an RA reporting method is provided, comprising: executing, by a user equipment (UE), a random access (RA) procedure; and when the RA procedure is successfully completed, determining, by the UE, that the RA procedure is not triggered by early TA acquisition for layer 1/layer-2 triggered mobility (LTM), and storing, by the UE, RA information corresponding to the RA procedure in an RA report.

In the RA reporting method according to the second aspect, the UE determines that the RA procedure is triggered by the early TA acquisition for LTM and configured with RAR reception, and the UE stores the RA information corresponding to the RA procedure in the RA report.

According to a third aspect of the present disclosure, a user equipment is provided, comprising: a processor; and a memory storing instructions, wherein the instructions, when run by the processor, execute the above RA reporting method.

### BENEFICIAL EFFECT OF THE PRESENT INVENTION

According to the RA reporting method executed by a user equipment and the user equipment in the present disclosure, reporting of LTM-specific performance information different from RA information corresponding to a transmission RA procedure can be implemented in an LTM-supported system, and random access information configuration for RA reporting can be implemented in an LTM scenario. In this way, a network side can differentiate between an RA procedure occurring in an LTM scenario and an RA procedure in a conventional non-LTM scenario. In addition, based on the LTM-specific information, the network side can analyze random access performance and LTM configurations in the LTM scenario and perform more refined parameter configuration optimization.

### BRIEF DESCRIPTION OF THE DRAWINGS

The above and other features of the present disclosure will become more apparent with the following detailed description in conjunction with the accompanying drawings.

FIG. 1 is a schematic flowchart of a contention-based four-step random access procedure.

FIG. 2 is a schematic flowchart of a contention-free random access procedure.

FIG. 3 is a schematic flowchart of a cell switch procedure based on an LTM mechanism.

FIG. 4 is a schematic flowchart of an RA reporting method according to Embodiment 1 of the present invention.

FIG. 5 is a schematic flowchart of an RA reporting method according to Embodiment 2 of the present invention.

FIG. 6 is a schematic flowchart of an RA reporting method according to Embodiment 3 of the present invention.

FIG. 7 is a block diagram of a user equipment according to an embodiment of the present disclosure.

### DETAILED DESCRIPTION OF PREFERRED EMBODIMENTS

According to the following detailed description of exemplary embodiments of the present disclosure made in conjunction with the accompanying drawings, other aspects, advantages, and prominent features of the present disclosure will become apparent to those skilled in the art.

In the present disclosure, the terms “include” and “comprise” and derivatives thereof mean inclusion and not limitation. The term “or” has an inclusive meaning and means “and/or”. In the present specification, the following various embodiments for describing the principles of the present disclosure are merely illustrative, and should not be interpreted in any way as limiting the scope of the disclosure. The following description with reference to the accompanying drawings is used to facilitate full understanding of the exemplary embodiments of the present disclosure defined by the claims and equivalents thereof. The following description includes a variety of specific details to facilitate understanding, but these details should be considered merely exemplary. Therefore, those of ordinary skill in the art should recognize that various changes and modifications may be made to the embodiments described herein without departing from the scope and spirit of the present disclosure. In addition, the description of the known function and structure is omitted for clarity and simplicity. In addition, the same reference numerals are used for similar functions and operations throughout the accompanying drawings.

A plurality of implementations according to the present disclosure are specifically described below by using an NR mobile communication system as an example application environment. However, it is to be noted that the present disclosure is not limited to the following implementations, and is applicable to other wireless communications systems, such as an LTE system connected to a 5G core network.

A base station in the present disclosure may be any type of base station, including a Node B, an enhanced base station eNB, or a base station gNB in a 5G communication system; or a micro base station, a pico base station, a macro base station, or a home base station, etc.; The network side generally refers to a base station or a cell. The cell may also be a cell covered by any type of base station described above. Unless otherwise specially stated, a cell, a beam, and a transmission point (TRP) are interchangeable. The base station may also be a gNB-central unit (gNB-CU) or a gNB-distributed unit (gNB-DU) that forms the base station. Different embodiments may also be combined with each other for operation. For example, the same variables/parameters/nouns in different embodiments may be interpreted identically. “Cancel”, “release”, “delete”, “clear”, and “remove” are interchangeable. “Execute”, “use”, and “apply” are interchangeable. “Configure” and “reconfigure” are interchangeable. “Monitor” and “detect” are interchangeable. “Initiate” and “trigger” are interchangeable.

Some existing mechanisms/conventional technologies involved in the present disclosure are first described below. It is worth noting that some names in the following description are merely illustrative rather than limiting, and other names may be used.

Physical random access channel resource: Physical random access channel (PRACH) resource. A base station broadcasts, via system information, a physical random access channel parameter configuration used by a cell. In the present disclosure, a physical random access channel (PRACH) resource may refer to a physical frequency resource and/or time domain resource and/or code domain resource (for example, a preamble) for random access.

Random access channel: Random access channel (RACH) refers to a channel for sending a random access preamble. In the present disclosure, the RACH may refer to a transport channel RACH, and may also refer to a physical random access channel (PRACH), with no differentiation made between them. RACH parameters/configurations refer to wireless configurations for implementing random access functions, including PRACH-related configurations, such as the maximum number of preambles sent, a power ramping parameter, a random access response reception window size, a medium access control (MAC) contention resolution timer configuration, a PRACH time-frequency resource configuration, message 1 (i.e., preamble) sub-carrier spacing, a configuration (configured by an ssb-perRACH-OccasionAndCB-PreamblesPerSSB information element) for indicating information about the number of synchronization signal blocks (SSB) corresponding to each RACH occasion (RO) and the number of contention-based random preambles corresponding to each SSB, a backoff parameter (in a scalingFactorBI information element), etc.

### Random Access (RA) Procedure:

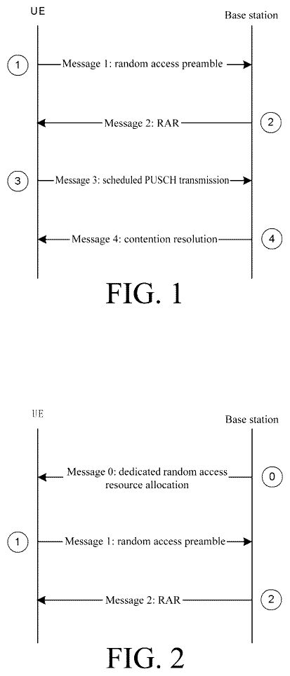

In existing NR mechanisms, random access procedures may be divided into contention-based random access (CBRA) and non-contention based random access (i.e., contention-free random access (CFRA)). As shown in FIG. 1, a CBRA procedure is divided into four steps: step 1: A UE sends message 1 (i.e., a random access preamble) to a base station; step 2: The UE receives message 2 (i.e., a random access response (RAR)) from the base station; step 3: The UE sends message 3 (an uplink transmission scheduled by an uplink grant in message 2), message 3 generally being used to send, to the base station, a UE identifier, a radio resource control (RRC) message used for RRC connection establishment/resume/reestablishment, a UE contention resolution identifier for random access contention resolution, etc. ; and step 4: The UE receives message 4 (i.e., a message for contention resolution) from the base station. The PRACH resources used in CBRA are shared by many UEs. After the UE completes the above-described four steps of random access of CBRA and contention resolution succeeds, the random access procedure is successfully completed. As shown in FIG. 2, a CFRA procedure is divided into two steps: step 1: A UE sends message 1 (i.e., a random access preamble) to a base station; and step 2: The UE receives message 2 (i.e., a random access response (RAR)) from the base station.

After successfully receiving message 2 associated with message 1, the UE considers that the CFRA procedure is successfully completed. In CFRA, the base station generally allocates a dedicated PRACH resource such as a preamble to the UE in advance (referred to as step 0 in FIG. 2), so that no contention is present. The two-step random access procedure is introduced to NR of R16 or later versions, including message A and message B. Step 1 and step 3 in the above four-step random access procedure are combined into one step for sending, which is referred to as message A. That is, message A contains a random access preamble and a subsequently associated PUSCH load. Content of the PUSCH load is consistent with content contained in message 3. The content of the PUSCH load may contain an RRC message, or may contain user plane data or a MAC control element such as a buffer status report or a UE identifier, etc. Step 2 and step 4 are combined into one step, which is referred to as message B. Message B is a response to message A in the two-step random access procedure. Content of message B is similar to content of message 2 and message 4 above, and may include a response for contention resolution (a contention resolution identifier, a random access preamble identifier, or a UE identifier, etc.), a fallback indication, a backoff indication, a timing advance command, an uplink grant, a corresponding response RRC message used to respond to the RRC message contained in message A, etc.

The UE may trigger a random access procedure in various cases, e.g., initial access executed by switching from an RRC idle state or an RRC inactive state (RRC_INACTIVE) to an RRC connected state, a beam recovery request, a handover (which may also be referred to as reconfiguration with sync in NR), etc., the UE in the RRC connected state encountering arrival of uplink data but experiencing uplink asynchronization at this time, the UE in the RRC connected state having no available physical uplink control channel (PUCCH) resources, etc.

### Random Access (RA) Report:

In the current NR system, the UE reports, to the network side, a report related to RA information in mainly three scenarios.

In a first type of RA information report, the UE records, in a variable VarRA-Report, RA information for each (successfully) completed random access procedure. For a random access report that records information about a random access procedure, the base station issues a UE information request (UEinformationRequest) message to the UE, where the message includes an RA report request indication (ra-ReportReq information element) to request the UE to report a stored RA report of the random access procedure. After receiving the UEinformationRequest message including the indication, the UE reports the stored RA report to the base station in a UE information response (UEinformationReponse) message. The base station uses an RA report reported by one UE as a sample. With sufficient samples, the base station can analyze whether current RACH performance meets requirements, and adjust RACH parameters as required to improve RACH performance.

A second type of report related to RA information is a connection establishment failure (CEF) report. If initial access fails (an RRC connection establishment procedure fails or an RRC connection resume procedure fails), a corresponding CEF report also stores random access information of a random access procedure executed during the RRC connection establishment/resume procedure. A UE variable VarConnEstFailReport is used to store information of the CEF report.

A third type of report related to RA information is a radio link failure (RLF) report. For example, when a radio link failure or reconfiguration with sync failure is triggered due to a random access failure, corresponding random access information is also stored in a corresponding radio link failure report. A UE variable VarRLF-Report is used to store information of the RLF report.

In general, an RA report refers to the first type of RA information report. In the following embodiments of the present disclosure, a specific implementation method is described by using an RA report as an example, but it should be noted that the implementation method is not limited to the foregoing first type of RA report, and the RA report in the present disclosure is also applicable to the second or third type of RA information report, or an alternatively named report reported by the UE to the network side.

An RA report in LTE mainly includes two instances of information about a random access procedure: one is the number of random access preambles sent (numberofpreamblesent), which is used to indicate the number of random access preambles sent in the random access procedure and which corresponds to a PREAMBLE_TRANSMISSION_COUNTER count value of a MAC layer; the other is a contention detection indication (contentiondetected), which is used to indicate whether contention is detected for at least one sent random access preamble. The RACH parameters that can be adjusted by the base station may include RACH resource configuration, random access preamble division, a RACH backoff parameter, a RACH transmit power control parameter, and so on.

An NR system of release 16 or later versions uses the above framework in LTE, and is enhanced with reference to characteristics of NR such as beam characteristics. The NR system supports a UE in storing RA information corresponding to a plurality of random access procedures. The UE can store up to eight RA reports. After entering the RRC idle or inactive state, the UE still stores a previously generated RA report. The UE sends the stored RA report to the network side after entering the connected state again.

When the UE successfully completes one random access procedure, if the UE determines that the number of Ra-report entries (number of entries) in a random access report list (ra-ReportList) stored in a current variable VarRA-Report is less than the maximum RA report number maxRAReport supported by the system, the UE appends a new entry in VarRA-Report to record information about this completed random access procedure. Information corresponding to one random access procedure may include: information about a cell (a global cell identity, a tracking area code, or a physical cell identity and a carrier frequency) in which a random access preamble is sent, random access purpose information, a special cell identity corresponding to the random access procedure, and random access common information. The random access common information includes reference downlink frequency information (for example, an absolute frequency of point A, a sub-carrier spacing, bandwidth and location information (locationAndBandwidth), etc.) associated with the random access procedure, and RA information associated with each random access attempt arranged in order of occurrence time.

The RA information associated with each random access attempt includes a beam index value, the number of consecutive random access attempts on the beam (i.e., the number of consecutive random access preambles sent corresponding to the beam), whether indication information of random access contention is detected, and indication information of whether a reference signal received power (RSRP) of a beam corresponding to a random access resource used by the random access attempt is higher than a configured threshold. RA information for the two-step random access procedure is added to an RA report of release 17, including: fallback information for fallback from the two-step random access procedure to the four-step random access procedure, downlink quality measured by the UE before the two-step random access procedure is triggered, etc.

### LTM Mechanism:

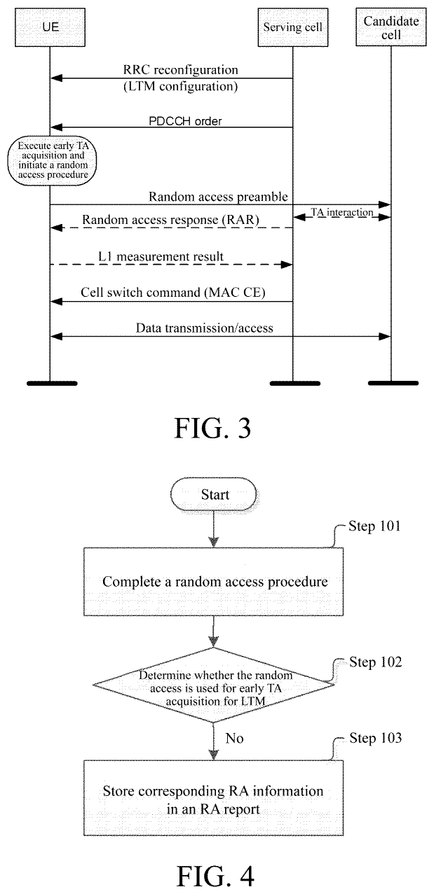

The 3GPP working group is currently discussing and standardizing the LTM mechanism. In a current reached conclusion, LTM may be used for a change of a serving cell in a master cell group (MCG), such as a change of a primary cell (PCell), or may be used for a change of a serving cell in a secondary cell group (SCG). A cell change using the LTM mechanism is referred to as a cell switch, which is distinguished from a conventional handover. As shown in FIG. 3, a network side sends an LTM candidate cell configuration to a UE in advance via RRC signaling (for example, an RRC reconfiguration message). After receiving the configuration, the UE stores the received LTM candidate cell configuration. The candidate cell configuration includes an RRC configuration corresponding to one or more candidate cells. The network side determines, based on a measurement result of layer 1 reported by the UE, a target cell that finally executes the cell change, and triggers a cell switch procedure via layer 1/layer 2 (L1/L2) signaling (for example, a MAC control element (CE)). The L1/L2 signaling for triggering the cell switch procedure at least includes indication information of a target candidate cell configuration (for example, a corresponding candidate (configuration) identity or an index value). The UE triggers the cell switch procedure and applies the stored, previously received LTM candidate cell configuration to execute a change procedure to the target cell.

In the LTM mechanism, in order to further reduce the delay of a cell change procedure, the network side may obtain an uplink timing advance (TA) amount of the candidate cell in advance before triggering the cell change, so that when the UE subsequently executes the cell switch procedure to the target cell, a random access procedure to the target cell may be omitted, and the obtained uplink TA value is directly used to perform uplink transmission. This manner is referred to as early TA acquisition in the present disclosure. The UE executes the early TA acquisition on a candidate cell based on an indication/configuration of the network side, that is, executes a random access procedure on the candidate cell to acquire a TA of the candidate cell, as shown in FIG. 3. In the current conclusion reached by the 3GPP, the UE uses a CFRA manner to acquire the early TA. The network side may configure a dedicated random access resource for the UE via a physical downlink control channel (PDCCH) order to trigger a random access procedure to a candidate cell, and may further indicate/configure, to the UE via an RRC message, whether a random access procedure with early TA acquisition is configured with random access response (RAR) reception. When the random access response reception is not configured, the UE sends, in a corresponding random access procedure, a random access preamble only to the candidate cell without monitoring/receiving an RAR. If the random access preamble sent by the UE is not successfully received by the network side, the network side may trigger, via the PDCCH order, the UE to resend the random access preamble. The network side records an obtained corresponding TA, and includes a TA value in the L1/L2 signaling for triggering the cell switch to notify the UE. When the random access response is configured, after sending the random access preamble on the LTM candidate cell, the UE needs to receive a corresponding RAR via a serving cell and store a TA value included in the RAR for uplink transmission of the subsequently triggered cell switch.

The foregoing characteristics of a random procedure in LTM cause distinctions from a conventional random access procedure, for example, whether the UE is required to receive the RAR is configured by the network side. Performing distinctive collection and recording for RA reports in different scenarios and performing more refined network status monitoring enable the network side to have more refined and accurate network parameters such as random access parameters in different scenarios. When the RAR is not configured, the random access procedure only includes sending of a random access preamble, and the power of sending the random access preamble is determined to be different from the power used in a conventional random access procedure. In this case, the present disclosure focuses on the problems of whether the UE needs to record in an RA report RA information corresponding to the random access procedure executed in this scenario and how to record the corresponding RA information. In addition, unlike a case in which conventional random access occurs on a serving cell, the random access procedure for early TA acquisition occurs on a non-serving cell, that is, an LTM candidate cell. Therefore, how to record such information in the RA report is also one of the problems to be solved in the present disclosure. Furthermore, the present disclosure also provides a method for determining that a UE ends a random access procedure.

The present disclosure mainly provides a solution to the foregoing problems related to RA reporting in an LTM-supported scenario. By using the solution of the present disclosure, the UE includes in an RA report information related to the RA procedure used for early TA acquisition in an LTM mechanism, so that the network side can know that the RA report is used in the LTM scenario for early TA acquisition and corresponding information, thereby executing more refined network parameter optimization such as optimization of random access parameter configurations corresponding to LTM, etc.

### EMBODIMENT 1

Embodiment 1 provides an RA reporting method for a random access procedure. In the method in this embodiment, in an LTM scenario, a UE does not record, in an RA report, random access information corresponding to a random access procedure for early TA acquisition, thereby avoiding overhead caused by unnecessary recording, and reducing energy consumption of the UE and corresponding signaling overhead. A background idea of this embodiment is that a network side does not perform random access parameter optimization on the random access procedure (especially a random access procedure when RAR reception is not configured) for early TA acquisition in the LTM scenario, or uses a network side-based method for parameter optimization of the random access procedure in the LTM scenario, for example, the network side records information of the random access procedure and performs optimization of corresponding random access parameters based on this, without relying on recording and reporting by the UE. The following describes the RA reporting method in Embodiment 1 in detail. FIG. 4 is a schematic flowchart of an RA reporting method according to Embodiment 1 of the present invention.

In step 101 in this embodiment, the UE completes a random access procedure. In step 102, when the UE completes the random access procedure, the UE determines whether the random access procedure is triggered by early TA acquisition for LTM. If not, the UE executes step 103. That is, when a trigger event of the random access is not the early TA acquisition for LTM, the UE records corresponding RA information in an RA report. Optionally, on the contrary, if yes, the UE does not record the corresponding RA information in the RA report.

Optionally, the UE completing a random access procedure means that the UE successfully completes a random access procedure.

Optionally, random access being triggered by the early TA acquisition for LTM means that the random access is triggered by a PDCCH order and is executed on an LTM candidate cell. Being executed on the LTM candidate cell means sending a random access preamble by using, on the LTM candidate cell, a PRACH resource or a RACH configuration corresponding to the LTM candidate cell.

Optionally, in step 102, when the UE determines that the trigger event of the random access is the early TA acquisition for LTM, and further, only when the UE determines that the random access is configured with an RAR, the UE records the corresponding RA information in the RA report. That is, the UE determines that the LTM candidate cell on which the random access procedure with the early TA acquisition for LTM is executed is configured with RAR reception, and records the corresponding RA information in the RA report. Being configured with the RAR (reception) means that it is configured that the UE needs to receive the RAR. The UE receives a RACH configuration for early TA acquisition from the network side via an RRC message, the RACH configuration including a configuration regarding whether the RAR needs to be received, and the RACH configuration being used to distinguish each LTM candidate cell configuration (or be associated with each candidate (configuration) identity/index).

Optionally, clearly, in this embodiment, before the UE completes a random access procedure, the method further includes the UE receiving a PDCCH order from a serving cell and executing an RA procedure on an LTM candidate cell indicated by the PDCCH order. The PDCCH order is used to trigger an RA procedure on an LTM candidate cell. Optionally, the PDCCH order includes at least an identifier/index value of the LTM candidate cell or an LTM candidate (configuration) index value.

### EMBODIMENT 2

Embodiment 2 provides an RA reporting method for a random access procedure for early TA acquisition in an LTM scenario. In the method of this embodiment, a UE indicates to a network side that the random access procedure is used for the early TA acquisition in the LTM scenario, and reports to the network side LTM-specific information corresponding to the random access procedure, so that the network side can distinguish an RA report of the random access procedure from an RA report corresponding to a conventional random access procedure, and optimize allocation and parameter configurations of a random access resource based on reported RA information that includes the LTM-specific information, thereby increasing a PRACH resource utilization rate and the probability of successful random access in the LTM scenario.

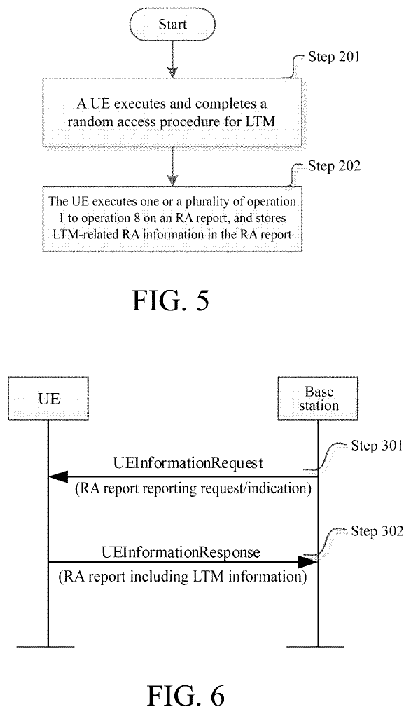

The following describes the RA reporting method in Embodiment 2 in detail. FIG. 5 is a schematic flowchart of an RA reporting method according to Embodiment 2 of the present invention.

Step 201: A UE completes a random access procedure in an LTM scenario.

Optionally, the completing a random access procedure means successfully completing a random access procedure.

Optionally, the random access procedure is used for early TA acquisition in the LTM scenario.

Optionally, with reference to Embodiment 1, this embodiment is executed when the following case is met: an LTM candidate cell corresponding to the executed random access procedure is configured with RAR (reception).

Step 202: The UE appends a new entry in an RA report variable (for example, VarRA-Report), and includes in the new entry one or a combination of a plurality of the following information associated with the random access procedure described in step 201. Specifically, the UE includes corresponding RA information in an RA report by executing one or a plurality of the following operations. This embodiment does not limit an execution order of the following operations by the UE.

Operation 1: Including, by the UE, first RA information in the RA report. The first RA information is used to indicate that the random access procedure is used for LTM, and further, is used to indicate that the random access procedure is used for early RA acquisition for LTM.

operation 2: Setting a value of an raPurpose information element to second RA information. The value of the second RA information indicates that a scenario in which the random access procedure is triggered is LTM, and further indicates that the scenario in which the random access procedure is triggered is the early TA acquisition for LTM or LTM-related triggered by a PDCCH order.

Optionally, the second RA information is actually an implementation of the first RA information. That is, the second RA information is a manner of implementing the first RA information via the raPurpose information element.

Operation 3: Setting the value of the raPurpose information element to ulUnSynchronized. That is, when the random access procedure is triggered by the PDCCH order on the LTM candidate cell, an raPurpose field is set to ulUnSynChronized. Optionally, further, when the random access procedure is triggered by the PDCCH order on an LTM candidate cell for early TA acquisition, the raPurpose field is set to ulUnSynChronized.

Operation 4: If the random access procedure is executed on an LTM candidate cell for an MCG, setting, by the UE, a value of third RA information to PCell information; or if the random access procedure is executed on an LTM candidate cell for an SCG, setting, by the UE, the value of the third RA information to PSCell information.

Optionally, if the random access procedure is triggered by the PDCCH order and is executed on the LTM candidate cell for the MCG, the UE sets the value of the third RA information to the PCell information; or if the random access procedure is triggered by the PDCCH order and is executed on the LTM candidate cell for the SCG, the UE sets the value of the third RA information to the PSCell information.

Operation 5: If the random access procedure is executed on the LTM candidate cell, setting, by the UE the value of the third RA information to the PCell information.

Optionally, if the random access procedure is triggered by the PDCCH order and is executed on the LTM candidate cell, the UE sets the value of the third RA information to the PCell information.

Optionally, if the random access procedure is executed on the LTM candidate cell but is not triggered by a cell switch command, the UE sets the value of the third RA information to the PCell information. Optionally, the cell switch command is a MAC CE used to trigger a cell switch.

In operation 4 or operation 5, optionally, the PCell information is a PCell identity, for example, a PCell global cell identity, or a physical cell identity and a carrier frequency. The PSCell information is a PSCell identity, such as a PSCell global cell identity, or a physical cell identity and a carrier frequency. Optionally, the third RA information is a spCellId field in the RA report.

Operation 6: If the random access procedure is executed on the LTM candidate cell, setting, by the UE the value of the third RA information to a serving cell identity configured by the network side. The serving cell identity configured by the network side refers to a cell configured by the network side for an associated LTM candidate cell to execute RAR reception for early TA acquisition. The network side configures, via an RRC message or L1/L2 signaling, a serving cell identity/index of the RAR reception when the UE executes RA on the LTM candidate cell. The configuration may be configured separately for each LTM candidate cell, or may be configured with one value for all LTM candidate cells. Optionally, the RA refers to RA triggered by the PDCCH order.

Operation 7: Setting a value of fourth RA information to indicate whether the RA is configured with RAR reception. When the RA is configured with the RAR reception, the value of the fourth RA information is set to indicate that the RA is configured with the RAR reception. Optionally, when the RA is not configured with the RAR reception, the value of the fourth RA information is set to indicate that the RA is not configured with the RAR reception. In an implementation, the UE includes the fourth RA information in the RA report only when the RA is configured with the RAR reception. In another implementation, the UE includes the fourth RA information in the RA report only when the RA is not configured with RAR reception.

The RA being configured with the RAR reception means that the LTM candidate cell on which the RA is executed or a candidate configuration associated with the candidate cell is configured with the RAR reception.

Operation 8: Setting a value of fifth RA information to indicate initial transmit power information of a random access preamble in the RA procedure.

Optionally, the initial transmit power information refers to transmit power information of a first-time random access preamble in the RA procedure.

Optionally, the initial transmit power information is an initial transmit power value or an initial transmit power index value.

Optionally, the initial transmit power information is a power ramping step or a step value that is used to calculate an initial transmit power. Optionally, the power ramping step or step value is acquired by the UE from the PDCCH order used to trigger the RA procedure.

Optionally, in operation 8, when the RA is not configured with the RAR reception, the UE includes the fifth RA information in the RA report.

In the foregoing embodiment, “configured with the RAR” and “configured with the RAR reception” are interchangeable. “Candidate cell”, “candidate configuration”, “cell indicated by a candidate (configuration) identity/index”, “target candidate cell”, and “candidate target cell” are interchangeable. The early TA acquisition for LTM or the early TA acquisition of the LTM candidate cell may be triggered by the PDCCH order to execute the RA procedure on the LTM candidate cell.

Optionally, before step 201, step 200 is further included. In step 200, the UE receives the PDCCH order on the serving cell and executes a random access procedure on the LTM candidate cell indicated by the PDCCH order. The PDCCH order is used to trigger an RA procedure on an LTM candidate cell. Optionally, the PDCCH order includes at least an identifier/index value of the LTM candidate cell or an LTM candidate (configuration) index value.

### EMBODIMENT 3

This embodiment provides an RA reporting method executed by UE. By means of the method described in this embodiment, the UE can report, in an RA report, LTM-related information to a base station, so as to provide more accurate RA information to the network side. This embodiment provides a method for a signaling flow when a UE reports the RA report in the above embodiments by means of an RRC procedure.

FIG. 6 is a schematic flowchart of an information reporting method according to Embodiment 3 of the present disclosure. As shown in FIG. 6, the information reporting method in Embodiment 3 of the present disclosure may include the following steps.

Step 301: UE receives a UE information request UEInformationRequest message from a network side, wherein the UEInformationRequest message carries an instruction/request used to request the UE to report a stored RA report.

Step 302: The UE includes, in a UE information response UEInformationResponse message, content in the stored RA, and sends the UEInformationResponse message to the network side. The RA report included in the UEInformationResponse message includes at least one or a combination of a plurality of the RA information (for example, the first RA information to the fifth RA information) in the foregoing Embodiment 2.

### EMBODIMENT 4

This embodiment provides a processing method for ending an RA procedure executed on a UE. In the method of this embodiment, when a random access procedure triggered for early TA acquisition on an LTM candidate cell reaches a maximum transmission count, the UE ends the RA procedure, does not continue the RA procedure, and does not need to indicate an RA problem to an upper RRC layer, so as to avoid unnecessary radio link failure.

Step 401: Executing, by the UE, the random access procedure triggered for the early TA acquisition on the LTM candidate cell.

Step 402: In the random access procedure, if a MAC layer determines that the number of random access preambles sent (for example, a value of a random access preamble transmission counter (PREAMBLE_TRANSMISSION_COUNTER)) is equal to a configured maximum preamble transmission value plus one, considering, by the UE, that the random access procedure is unsuccessfully ended.

Optionally, before step 401, step 400 is further included. In step 400, the UE receives a PDCCH order and executes a random access procedure on an LTM candidate cell indicated by the PDCCH order. The PDCCH order is used to trigger an RA procedure on an LTM candidate cell. Optionally, the PDCCH order includes at least an identifier/index value of the LTM candidate cell or an LTM candidate configuration index value.

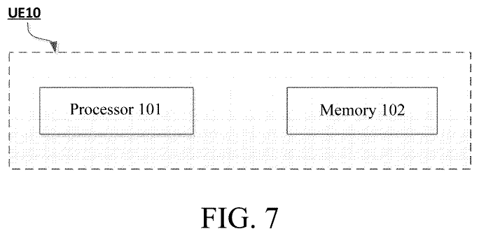

FIG. 7 is a block diagram of a user equipment 10 according to an embodiment of the present disclosure. As shown in FIG. 7, the user equipment 10 includes a processor 101 and a memory 102. The processor 101 may, for example, include a microprocessor, a microcontroller, and an embedded processor. The memory 102 may, for example, include a volatile memory (for example, a random access memory (RAM)), a hard disk drive (HDD), a non-volatile memory (for example, a flash memory), or other memories. The memory 102 has program instructions stored thereon. The instructions, when run by the processor 101, may execute the random access reporting method applied to the user equipment described in detail in the present disclosure.

A program running on a device according to the present disclosure may be a program that enables a computer to implement the functions of the embodiments of the present disclosure by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present disclosure may be recorded on a computer-readable recording medium. The corresponding functions may be achieved by causing a computer system to read programs recorded on the recording medium and executing the programs. The so-called “computer system” may be a computer system embedded in the device, which may include operating systems or hardware (for example, peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by means of circuits (e.g., monolithic or multi-chip integrated circuits). Circuits designed to execute the functions described in the present specification may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present disclosure may also be implemented using these new integrated circuit technologies.

Furthermore, the present disclosure is not limited to the embodiments described above. Although various examples of the described embodiments have been described, the present disclosure is not limited thereto. Fixed or non-mobile electronic devices installed indoors or outdoors, such as AV devices, kitchen devices, cleaning devices, air conditioners, office devices, vending machines, and other household appliances, may be used as terminal devices or communications devices.

The embodiments of the present disclosure have been described in detail above with reference to the accompanying drawings. However, the specific structures are not limited to the above embodiments. The present disclosure also includes any design modifications that do not depart from the substance of the present disclosure. In addition, various modifications may be made to the present disclosure within the scope of the claims. Embodiments resulted from the appropriate combinations of the technical means disclosed in different embodiments are also included within the technical scope of the present disclosure. In addition, components with the same effect described in the above embodiments may be replaced with one another.

1-10. (canceled)

11. A User Equipment (UE), comprising
a processor configured to:
successfully complete a random access (RA) procedure,
append a new entry in an RA report variable, and
include, in the new entry, random access information to indicate that the random access procedure is initiated for L1/L2 triggered mobility (LTM), in a case that the random access procedure is for LTM.

12. A base station, comprising
a processor configured to:
receive a random access (RA) report variable from a user equipment that successfully complete a random access (RA) procedure, wherein
an entry is appended in the RA report variable, and
the entry includes random access information to indicate that the random access procedure is initiated for L1/L2 triggered mobility(LTM), in a case that the random access is for LTM.

13. A method performed by a User Equipment (UE), comprising:
successfully completing a random access (RA) procedure,
appending a new entry in an RA report variable, and
including, in the new entry, random access information to indicate that the random access procedure is initiated for L1/L2 triggered mobility (LTM), in a case that the random access procedure is for LTM.
